(19) United States
(12) Patent Application Publication
(10) Pub. No.: US 2014/0196075 A1
(43) Pub. Date: Jul. 10, 2014

(54) CONTROL METHOD, DEVICE, AND SYSTEM BASED ON USER PERSONAL ACCOUNT

(71) Applicant: HUMAX CO., LTD., Seongnam-si (KR)

(72) Inventor: Sung Heum PARK, Yongin-si (KR)

(73) Assignee: HUMAX CO., LTD., Seongnam-si (KR)

(21) Appl. No.: 14/149,755

(22) Filed: Jan. 7, 2014

(30) Foreign Application Priority Data
Jan. 10, 2013 (KR) 10-2013-0002969

(51) Int. Cl. H04N 21/475

(52) U.S. Cl. CPC H04N 21/4753
USPC 725/30

(57) ABSTRACT

A control method based on a user personal account may include receiving a first control message, including first user personal account information and first control information, from a first terminal, logging into a first user personal account corresponding to the first user personal account information based on the first user personal account information included in the first control message, and performing an operation corresponding to the first control information based on predetermined first user service policy information associated with the first user personal account.

Priority to Korean patent application number 2013-0002969 filed on Jan. 10, 2013, the entire disclosure of which is incorporated by reference herein, is claimed.

### BACKGROUND

1. Field of the Invention

Embodiments of the present invention relate to a control method, device, and system based on a user personal account and, more particularly, to a technology in which a service is provided by device, such as in smart TV and IPTV, based on a user personal account without a manual login or logout procedure.

2. Discussion of the Related Art

Recently, a network infrastructure for ultrahigh-speed data communication has been developed, and various types of services are increasingly provided based on the network infrastructure. Thus, Internet Protocol TV (IPTV), which provides information services, video content, and broadcasting based on ultrahigh-speed Internet, has become widely popular.

Since all that is needed to implement IPTV is a set-top box for accessing the Internet and a TV receiver operating in conjunction with the set-top box, IPTV is easy to use with common TV manipulation methods. IPTV is similar to cable broadcasting or satellite broadcasting in that it provides video and broadcasting content. However, unlike cable and satellite broadcasting, IPTV is characterized by bi-directivity. Accordingly, even users who are not accustomed to computers can easily perform Internet searches and receive various types of content and supplementary services provided through the Internet, such as watching movies, home shopping, home banking, online gaming, and listening to music, using a remote controller. As smart TVs equipped with smart functions have developed, an increasingly wide variety of services can be provided.

IPTV is often used by several members of a family in a home, and thus a service account for IPTV is often managed through a family account. In order to provide different services that are personalized for different members of a home, use of multiple profiles has been proposed in which an access account for IPTV service is managed according to each member of a family, that is, each user.

Such multiple profile management can provide personalized service. By using multiple profiles, a personal configuration, a program watch range, a user interface form, and an information display range of an Electronic Program Guide (EPG) can be controlled in various ways, depending on the current viewer, for example, even in one IPTV.

Generally, in order to log in to IPTV service using the personal account of a user, the user needs to select an On Screen Display (OSD) in an IPTV screen and enter a PIN code. After using the IPTV service, the user needs to log out in order to protect his information. That is, for a plurality of users to access an IPTV service using a single IPTV, a complicated procedure for logging in and logging out using a personal account is necessary.

In order to reduce such user efforts, devices that provide solutions capable of logging in to personal accounts through facial recognition or fingerprint recognition have recently appeared. However, the devices for implementing these solutions are expensive and have frequent errors in recognition, and thus are not sufficient to solve the problem.

(Patent Document 1) Korean Patent Laid-Open Publication No. 2009-0044758

### SUMMARY

An object of the present invention is to provide a control method, device, and system based on a user's personal account. An embodiment is directed to easily controlling the operation of a device, such as smart TV or IPTV, based on a personal account of a user.

An embodiment of the present invention provides a control method based on a user personal account. The control method includes receiving a first control message, including first user personal account information and first control information, from a first terminal, logging in to a first user personal account corresponding to the first user personal account information based on the first user personal account information included in the first control message, and performing an operation corresponding to the first control information based on predetermined first user service policy information associated with the first user personal account.

The first user personal account information may include Identification information for identifying the first user personal account and authentication information for authenticating the first user personal account. The first control information may include a key control value for controlling a device so that the device performs the operation.

The control method may further include storing the first user personal account information received from a server. The logging in to the first user personal account may include extracting the first user personal account information included in the first control message, comparing the extracted first user personal account information with the stored first user personal account information, and logging in to the first user personal account if, as a result of the comparison, the extracted first user personal account information is found to be identical with the stored first user personal account information.

The control method may further include, after performing the operation corresponding to the first control information, receiving a second control message, including second user personal account information and second control information, from a second terminal, logging out from the first user personal account and logging in to a second user personal account corresponding to the second user personal account information, based on the second user personal account information included in the second control message, and performing an operation corresponding to the second control information based on second user service policy information associated with the second user personal account.

The control method may further include, after performing the operation corresponding to the first control information, receiving a third control message, including the first user personal account information and third control information, from the first terminal, maintaining a current login state based on the first user personal account information included in the third control message, and performing an operation corresponding to the third control information based on the first user service policy information.

The control method may further include, after performing the operation corresponding to the first control information, receiving a fourth control message including fourth control information from a third terminal, checking that user personal account information is not included in the fourth control message, and logging out from the first user personal account based on the check.

The control method may further include performing an operation corresponding to the fourth control information based on family policy information associated with a predetermined family account after logging out from the first user personal account.

The control method may further include receiving family account information from a server upon initial activation, storing the family account information, and registering the received first user personal account information as an individual account associated with the family account information when the first user personal account information is received from the server.

Another embodiment of the present invention provides a device operating based on a user personal account. The device includes a terminal communication unit for receiving a first control message, including first user personal account information and first control information, from a first terminal, a login management unit for logging in to a first user personal account corresponding to the first user personal account information based on the first user personal account information included in the first control message, and a control unit for performing an operation corresponding to the first control information based on predetermined first user service policy information associated with the first user personal account.

The first user personal account information may include Identification information for identifying the first user personal account and authentication information for authenticating the first user personal account. The first control information may include a key control value for controlling a device so that the device performs the operation.

The terminal communication unit may receive a second control message, including second user personal account information and second control information, from a second terminal in the state in which the device logs in to the first user personal account. The login management unit may make the device log out from the first user personal account and log in to a second user personal account corresponding to the second user personal account information, based on the second user personal account information included in the second control message. The control unit may perform an operation corresponding to the second control information based on second user service policy information associated with the second user personal account.

The terminal communication unit may receive a third control message, including the first user personal account information and third control information, from the first terminal in the state in which the device logs in to the first user personal account. The login management unit may maintain a current login state based on the first user personal account information included in the third control message. The control unit may perform an operation corresponding to the third control information based on the first user service policy information.

The terminal communication unit may receive a fourth control message including fourth control information from a third terminal in the state in which the device logs in to the first user personal account. The login management unit may check that user personal account information is not included in the fourth control message and makes the device log out from the first user personal account based on the check. The control unit may perform an operation corresponding to the fourth control information based on family policy information associated with a predetermined family account after the logout.

In yet another embodiment of the present invention, a control system based on a user personal account is provided. The control system includes a first terminal for sending a first control message including first user personal account information and first control information and a service device for receiving the first control message, logging in to a first user personal account corresponding to the first user personal account information based on the first user personal account information included in the first control message, and performing an operation corresponding to the first control information based on predetermined first user service policy information associated with the first user personal account.

The first user personal account information may include Identification information for identifying the first user personal account and authentication information for authenticating the first user personal account. The first control information may include a key control value for controlling the service device so that the service device performs the operation.

The control system may further include a second terminal for sending a second control message including second user personal account information and second control information. In this case, when the second control message is received from the second terminal after performing the operation corresponding to the first control information, the service device may log out from the first user personal account and log in to a second user personal account corresponding to the second user personal account information, based on the second user personal account information included in the second control message, and may perform an operation corresponding to the second control information based on second user service policy information associated with the second user personal account.

The first terminal may send a third control message, including the first user personal account information and third control information, to the service device after the service device performs the operation corresponding to the first control information. The service device may maintain a current login state based on the first user personal account information included in the third control message and performs an operation corresponding to the third control information based on the first user service policy information, when the third control message is received.

The control system may further include a third terminal for sending a fourth control message including fourth control information. When the fourth control message including the fourth control information is received from the third terminal after performing the operation corresponding to the first control information, the service device may check that user personal account information is not included in the fourth control message, log out from the first user personal account, and perform an operation corresponding to the fourth control information based on family policy information associated with a predetermined family account.

The control system may further include a server for generating the first user personal account and sending the first user personal account information, corresponding to the generated first user personal account, to the service device.

In yet another embodiment of the present invention, a control system based on a user personal account is provided. The control system based on a user personal account may include a server for generating N (N is an integer equal to or greater than 1) user personal accounts and sending N pieces of user personal account information and N pieces of user service policy information corresponding to the N user personal accounts; a service device for storing the N pieces of user personal account information and the N pieces of user service policy information from the server; and N terminals corresponding to the N pieces of user personal account information, that is, remote controllers for sending respective control messages for remotely controlling the service device.

When a control message is received from any one of the N terminals, the service device may log in to a user personal account corresponding to user personal account information using user personal account information included in the control message and perform an operation corresponding to control information based on a user service policy information associated with the logged-in user personal account.

The server may generate and manage family profile information, including a family account and family service policy information corresponding to the service device, when the service device is initially activated, include each user personal account associated with the family account in the family profile information and manage the user personal account whenever the user personal account is generated, and send the family profile information to the service device.

The service device may determine whether or not the user personal account information included in the control message is identical with user personal account information about a current log-in user personal account, maintain the current log-in user personal account if, as a result of the determination, it is determined that the user personal account information is identical with user personal account information, and log out from the current log-in user personal account and then log in using the user personal account information included in the control message if, as a result of the determination, it is determined that the user personal account information is identical with user personal account information. When a control message not including a user personal account is received, the service device may log out from the current log-in user personal account.

### BRIEF DESCRIPTION OF THE DRAWINGS

FIG. 1 is a diagram illustrating a control system based on a user personal account in accordance with an embodiment of the present invention.

FIG. 2 is a block diagram illustrating elements of a server in accordance with an embodiment.

FIG. 3 is a block diagram illustrating elements of a service device in accordance with an embodiment.

FIG. 4 is a flowchart illustrating an operation of a control system based on a user personal account in accordance with an embodiment of the present invention.

FIG. 5 is a flowchart illustrating another operation of a control system based on a user personal account in accordance with an embodiment of the present invention.

### DETAILED DESCRIPTION

Embodiments of the present invention as described in the present disclosure may be modified in various ways. The present invention may be implemented by several embodiments. Specific embodiments of the present invention are illustrated in the drawings and are described in the present disclosure. It is, however, to be noted that the present invention is not intended to be limited to the specific embodiments described herein, but is intended to include all modifications, equivalents, or substitutions which fall within the spirit and technical scope of the present invention.

Terms, such as ‘the first’ and ‘the second,’ may be used to describe various elements, but the elements should not be restricted by the terms. The terms are used to only distinguish one element and the other element from each other. For example, a first element may be named a second element without departing from the scope of the present invention. Likewise, a second element may be named a first element. A term ‘and/or’ includes a combination of a plurality of pertinent and described items or any one of a plurality of pertinent and described items.

When it is said that one element is ‘connected to’ or ‘coupled with’ the other element, it should be understood that one element may be directly connected to or coupled with the other element, but a third element may exist between the two elements. In contrast, when it is said that one element is ‘directly connected to’ or ‘directly coupled with’ the other element, it should be understood that a third element does not exist between the two elements.

Terms used in this application are used to describe specific embodiments and are not intended to restrict the present invention. An expression of a singular number includes an expression of a plural number unless context clearly indicates otherwise. In the present disclosure, terms, such as ‘comprise’ or ‘have’, are intended to designate that characteristics, numbers, steps, operations, elements, or parts which are described in the specification, or a combination of them exist. These terms should not be understood to exclude the existence or possible addition of one or more other characteristics, numbers, steps, operations, elements, parts, or combinations of them in advance.

All terms used herein, unless otherwise defined, have the same meanings as those typically understood by those having ordinary skill in the art. Terms that may be defined in common dictionaries should be interpreted to have the same meanings as terms in the context of pertinent technology, and should not be interpreted to have ideal or excessively formal meanings unless clearly indicated in the present disclosure.

Hereinafter, embodiments of the present invention will be described in detail with reference to the accompanying drawings. In describing embodiments of the present invention, in order to enhance understanding, the same reference numerals designate the same or like elements throughout the drawings and redundant descriptions of the same elements will be omitted.

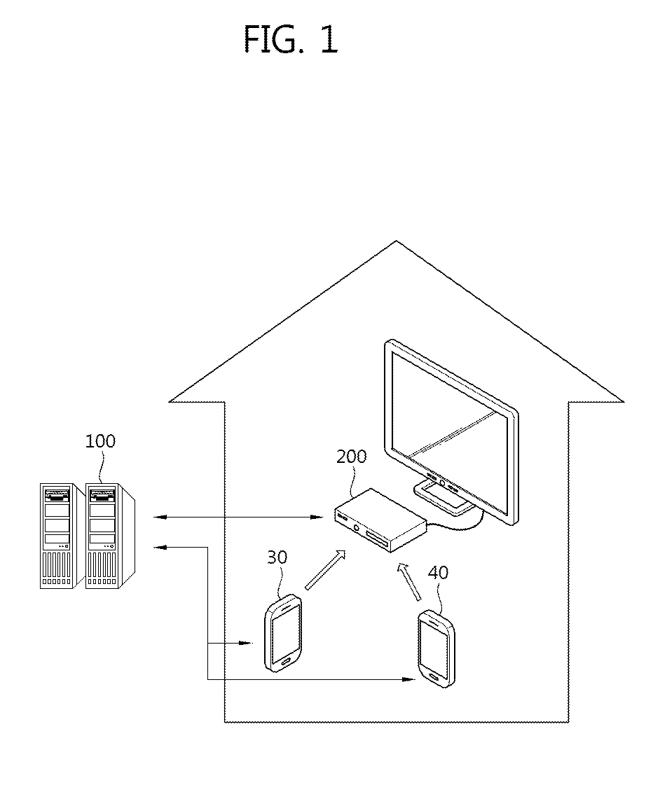

FIG. 1 is a diagram illustrating a control system based on a user personal account in accordance with an embodiment of the present invention.

As shown in FIG. 1, a control system based on a user personal account in accordance with an embodiment of the present invention may include a server 100, a service device 200, and a plurality of terminals 30 and 40.

The server 100 provides IPTV services, such as broadcasting programs, Video on Demand (VoD) service, and supplementary services. The server 100 may generate, store, send, and manage a family account corresponding to the service device 200 and at least one user personal account included in the family account.

The service device 200 is a device for providing IPTV services within a home and may be, for example, a set-top box or a smart TV set included in the home. The service device 200 may communicate with the server 100 through the Internet, and the service device 200 may be controlled by one or more terminal 30 or 40 having a wireless remote control function. The service device 200 may manage family account information, family service policy information, and one or more user personal account including user personal account information and user service policy information associated with the family account information from the server unit 100. That is, the service device 200 can support a multi-profile service. For example, the service device 200 may manage a family account including one or more user personal account.

The service device 200 may operate based on a user personal account. The service device 200 performs an operation specific to each user personal account. For example, the service device 200 may perform an operation based on first user personal account information or second user personal account information, which is included in a control message received from the first terminal 30 corresponding to a first user personal account or the second terminal 40 corresponding to a second user personal account.

For convenience of description, two user personal accounts within one family account have been illustrated (i.e., the first user personal account and the second user personal account), but embodiments of the present invention are not limited thereto. The number of user personal accounts within one family account may be 3 or more depending on an implementation environment. That is, the number of user personal accounts within a family account may be N, where N is an integer equal to or greater than 1.

The at least one terminal (e.g., the first terminal 30 corresponding to the first user personal account and the second terminal 40 corresponding to the second user personal account in the present embodiment) may have a remote controller function. In an embodiment, each of the first terminal 30 and the second terminal 40 may be a smart phone or a Personal Digital Assistant (PDA) having a remote controller application for controlling the service device 200 installed therein. In another embodiment, the first terminal 30 and the second terminal 40 may be a dedicated remote controller for controlling the service device 200 having an arithmetic operation processing function, for example, a dedicated remote controller for controlling a set-top box or smart TV.

The first terminal 30 and the second terminal 40 provide the first user personal account and the second user personal account in respective control messages, which also include control information. The first terminal 30 and the second terminal 40, respectively, send the control messages to the service device 200 to instruct the service device 200 to perform operations. That is, each of the first terminal 30 and the second terminal 40 sends a user personal account corresponding to each terminal to the service device 200 along with the control information.

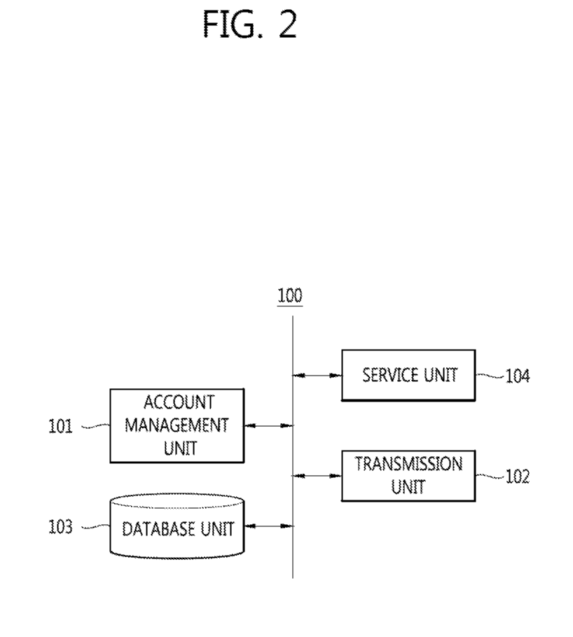

Elements of a control system in accordance with an embodiment are described below with reference to FIG. 2.

FIG. 2 is a block diagram illustrating elements of a server 100 in accordance with an embodiment.

As shown in FIG. 2, the server 100 may include a service unit 104, an account management unit 101, a transmitter 102, and a database 103. Elements of the server 100 may be implemented through one computer or a plurality of computer terminals, which may exchange data while communicating with each other.

The service unit 104 can provide IPTV services to the service device 200 through the Internet. For example, the service unit 104 may send an Electronic Program Guide (EPG) to the service device 200 and send content, requested by the service device 200, to the service device 200 using a streaming method or a download method. Furthermore, the service unit 104 may provide various types of supplementary services, such as games, e-commerce, and banking services to the service device 200. Services provided by the service unit 104 may be limited based on service policy information managed by the account management unit 101.

The account management unit 101 can perform a function of generating and managing a family account for IPTV services and information related to a user personal account. For example, when the service device 200 is initially activated, the account management unit 101 may generate a family account corresponding to the service device 200 and generate and manage family service policy information corresponding to the family account. The account management unit 101 may send family account information and family service policy information to the service device 200. The service device 200 can manage family account information and family service policy information received from the account management unit 101.

The account management unit 101 can generate a user personal account based on information received from a terminal of a user. The account management unit 101 can generate and manage user service policy information associated with the generated user personal account. For example, the account management unit 101 may generate a first user personal account and first user service policy information corresponding to the first user personal account, in response to information provided by a first user. Furthermore, the account management unit 101 may generate additional user personal accounts and user service policy information corresponding thereto, for each additional user. For example, the account management unit 101 may generate a second user personal account and second user service policy information corresponding to the second user personal account, in response to information provided by a second user. The account management unit 101 may send user personal account information and user service policy information, corresponding to each user personal account, to the service device 200.

The account management unit 101 may provide and manage an account management user interface to receive information from a user. In an embodiment, the account management unit 101 manages a user account management webpage in order to receive information necessary to generate a user personal account associated with the terminal of a user. The user account management webpage can provide a user interface through which a user can generate his or her user personal account and set pieces of related information on the web. The user may access the user account management webpage using a terminal associated with the user, for example, the first terminal 30 of a first user or the second terminal 40 of a second user, or using another terminal that is not specifically associated with a user. In an embodiment, the terminal of a user which accesses the server unit 100 in order to set up a user personal account may be any type of terminal capable of accessing the user interface (e.g., a webpage)to input information, such as a PC, a laptop, or a smart phone.

In an embodiment, the account management user interface requests user personal account identification information, authentication information for authenticating a user personal account, and service device identification information from the user through the terminal, and receives user personal account identification information, authentication information, and service device identification information from the terminal.

The account management unit 101 generates a user personal account using the user personal account identification information and authentication information. The user personal account identification information may include an identifier (ID) of a personal account. The authentication information may include a password, a certificate, fingerprint information, or PIN code.

The service device identification information may include an identifier unique to the service device 200, which can uniquely identify the service device 200. For example, the service device identification information may include a model number or a Media Access Control (MAC) value of the service device 200. The service device identification information may be associated with the user personal account, and is stored and managed in the database 103 of the server 100.

In an embodiment, user personal accounts having the same service device identification information may be bound to the same family account. For example, if a first user personal account and a second user personal account are associated with the same service device identification information, the first user personal account and the second user personal account are included in the same family account, and are both managed by the account management unit 101.

When a user personal account is generated, the account management unit 101 generates user service policy information associated with the generated user personal account. The database 103 of the server 100 stores and manages the generated user service policy information. To this end, a user account management user interface managed by the account management unit 101 allows a user to set a personal configuration, which is specific to the user, for receiving an IPTV service.

For example, the user interface may allow a user to set a desired EPG format, an EPG information display range, programs of interest, an IPTV service user interface type, and a program watch range in various ways. The account management unit 101 generates user service policy information based on personal configurations set by a user. In an embodiment, the user service policy information may include parameters for accessing an IPTV service, such a license, age limitations, etc., based on the user personal account in addition to the personal configurations set by the user. The generated user service policy information is associated with the user personal account and stored and managed by the database 103 of the server 100.

The transmitter 102 sends user personal account information and user service policy information, corresponding to each user personal account generated by the account management unit 101, to the service device 200. Each piece of user personal account information may include user personal account identification information and authentication information necessary to authenticate the user personal account identification information. The user personal account identification information of the user personal account information may be the ID that was used to generate a user personal account. The authentication information may include, for example, a PIN code or a password, a certificate, or fingerprint information that was used to generate a user personal account.

The service device 200 registers each piece of user personal account information and user service policy information corresponding to the piece of user personal account information, received from the server 100, as an individual user personal account within a family account, and performs multi-profile management based on the registered user personal account information and user service policy information.

For example, if the first user personal account information and the first user service policy information have been received from the server 100, the service device 200 registers the first user personal account as an individual account associated with a family account corresponding to the service device 200, and manages the first user personal account information and the first user service policy information in association with the first user personal account.

Similarly, if the second user personal account information and the second user service policy information have been received from the server 100, including the same service device identification information as the first user personal account, the service device 200 adds the second user personal account as another individual account associated with the family account corresponding to the service device 200, and manages the second user personal account information and the second user service policy information in association with the second user personal account.

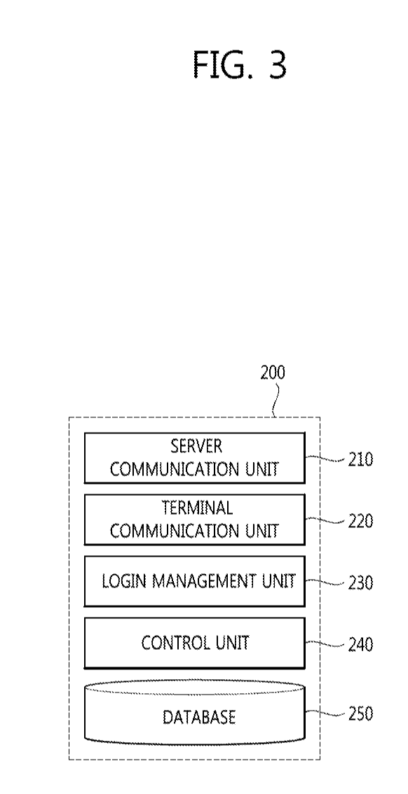

Elements of a service device in accordance with an embodiment are described below with reference to FIG. 3.

The service device 200 may be, for example, a set-top box or smart TV capable of receiving an EPG from the server 100 and providing an IPTV service. The service device 200 and receives and provides IPTV services such as content, real-time broadcasting of programs, and supplementary services based on the EPG. As shown in FIG. 3, the service device 200 may include a server communication unit 210, a terminal communication unit 220, a login management unit 230, a control unit 240, and a database 250. The service device 200 may further include various elements for providing IPTV services, but such elements are known in the art and descriptions thereof are omitted for convenience of illustration.

The server communication unit 210 communicates with the server 100 through the Internet. For example, when the service device 200 is initially activated, the server communication unit 210 receives family account information and family service policy information from the server 100. Furthermore, the server communication unit 210 receives user personal account information and user service policy information, which is generated whenever a new user personal account is created, from the server 100. The user personal account information, the user service policy information, the family account information, and the family service policy information received by the server communication unit 210 is stored in the database 250 of the service device 200 under the control of the control unit 240.

The terminal communication unit 220 can receive a control message from one or more terminals having a remote controller function, for example, the first terminal 30 or the second terminal 40. In an embodiment, the terminal communication unit 220 receives a control message for controlling a service from the first terminal 30. The control message received from the first terminal 30 includes control information, which is information for controlling an operation of the service device 200 when it provides an IPTV service, and first user personal account information. The terminal communication unit 220 is also configured to receive a control message for controlling a service from additional terminals, e.g., the second terminal 40. The control message received from the second terminal 40 may include control information for controlling an operation of the service device 200 and second user personal account information.

The login management unit 230 can perform a function of logging into a user personal account in the service device 200 that corresponds to the user personal account information included in the control message, which is received through the terminal communication unit 220. For example, if a control message including first user personal account information and specific control information is received from the first terminal 30, the login management unit 230 compares the first user personal account information, included in the received control message, with pieces of user personal account information previously stored in the database 250. If the first user personal account information corresponds to user personal account information previously stored in the database 250, the login management unit 230 logs in to a first user personal account. Similarly, if a control message including second user personal account information and control information is received from the second terminal 40, the login management unit 230 compares the second user personal account information, included in the control message, with pieces of user personal account information previously stored in the database 250, and logs in to a second user personal account if, as a result of the comparison, the second user personal account information in the control message received from the second terminal 40 is found to correspond to user personal account previously stored in the database 250.

When a new control message is received through the terminal communication unit 220, the login management unit 230 confirms whether or not user personal account information is included in the new control message, and determines whether or not the received user personal account information corresponds to a user personal account that the service device 200 is currently logged into. If it is determined that the received user personal account information corresponds to a user personal account that the service device is already logged into, the login management unit 230 maintains the current log-in status of the user personal account. If it is determined that the received user personal account information corresponds to a user personal account that is not currently logged in, the login management unit 230 may log out the currently logged-in user personal account and then log into the personal account corresponding to the newly received user personal account information included new control message.

For example, if the login management unit 230 has logged in the first user personal account, then when the login management unit 230 receives user personal account information included in a new control message received through the terminal communication unit 220, the login management unit 230 confirms whether or not the newly received user personal account information exists in the database 250 and determines whether the newly received user personal account information corresponds to the already-logged in first user personal account. If the confirmed user personal account information corresponds to the first user personal account information, the login management unit 230 maintains the current log-in state because the current log-in account is the same as the first user personal account. If the confirmed user personal account information corresponds to another user personal account, for example, if it is second user personal account information, the login management unit 230 may log out from the first user personal account and log in to a second user personal account because the currently logged-in account is different from the second user personal account.

In an embodiment, the login management unit 230 determines whether or not user personal account information has been included in a newly received control message and logs out if, as a result of the determination, user personal account information is not included in the newly received control message. For example, if the login management unit 230 has logged in a first user personal account, the login management unit 230 determines whether or not user personal account information has been included in a newly received control message, and logs out the currently logged-in first user personal account if it is determined that user personal account information is not included in the newly received control message. After the logout, the login management unit 230 considers the service device 200 as being logged in to a family account. That is, in an embodiment, the login management unit 230 manages login states of the user device 200 such that a family account login state is the default state.

The control unit 240 performs an operation indicated in a control message based on user service policy information corresponding to user personal account information. The control message and user personal account information are included in a control message that is received from the terminal 30 or 40. To this end, in an embodiment, the control unit 240 manages a table which includes control information and an operation guide corresponding to the control information.

For example, if a first user personal account has logged in, the control unit 240 performs an operation corresponding to control information received in a control messaged, in accordance with a first user service policy corresponding to the first user personal account. That is, an operation corresponding to a command indicated in a control message received from the first terminal 30 (i.e., a command according to a control message that includes first user personal account information) is performed according to first user service policy information, which corresponds to the first user personal account. If a second user personal account has logged in, the control unit 240 can perform an operation corresponding to control information received in a control message, in accordance with a second user service policy, which corresponds to the second user personal account. That is, an operation corresponding to a command indicated in a control message received from the second terminal 40 (i.e., a command according to a control message that includes second user personal account information) is performed according to second user service policy information, which corresponds to the second user personal account. In an embodiment, if all user personal accounts have logged out, the control unit 240 performs an operation corresponding to control information based on the family service policy information of a family account.

A plurality of terminals for remotely controlling the service device 200, for example, the first terminal 30 and the second terminal 40, may be remote controllers used by a plurality of users, for example, a first user and a second user, respectively. In an embodiment, the remote controller may be a smart phone having a remote controller application installed therein or a personal, dedicated remote controller having an arithmetic operation function.

The first terminal 30 and the second terminal 40 store first user personal account information and second user personal account information, respectively. To this end, in an embodiment, each of the first terminal 30 and the second terminal 40 displays a user interface through which user personal account information can be inputted and stores the inputted user personal account information.

If the first user inputs a selection in the first terminal 30 in order to control the service device 200, the first terminal 30 sends a control message, including control information corresponding to the selection and first user personal account information that has been previously stored, to the service device 200. Likewise, if the second user inputs a selection in the second terminal 40 in order to control the service device 200, the second terminal 40 sends a control message, including control information corresponding to the selection and second user personal account information that has been previously stored, to the service device 200.

A control system based on a user personal account in accordance with an embodiment of the present invention has been described above. In accordance with an embodiment of the present invention, a first user being provided with IPTV services through the service device 200 within a home, for example, can be provided with services specific to the first user because the first user has registered a first user personal account through an interface (e.g., a webpage) provided by the server 100, including first user personal account information associated with the first terminal 30, that is, his or her terminal, and is automatically logged in to the first user personal account by simply using the first terminal 30 to control the service device 200. Accordingly, the first user does not need to input additional information in order to log in to the service device 200 using his or her personal account.

If a second user controls the service device 200 using his or her terminal while the service device 200 is logged in to a first user personal account, the first user personal account is automatically logged out and a second user personal account is automatically logged in. Accordingly, a first user does not need to input an additional logout command after using IPTV services, and the second user can be provided with services specific to the second user because the second user is automatically logged into the second user personal account, without having to input additional login information.

If a third user transmits a control message to the service device 200 through another remote controller associated with the third user, but the third user's user personal account information has not been registered, then, if the service device 200 is logged in to, e.g., the first user personal account, the first user personal account is automatically logged out, and the current login state of the service device 200 automatically shifts to a family account login state. Accordingly, a first user does not need to input an additional logout command after using IPTV services, and the third user can be provided with services through a family account.

A control system and various elements of a control system have been described with reference to FIGS. 1-3. Embodiments in accordance with the present invention may be implemented as a computer system, e.g., as a computer readable medium. Although descriptions of some known components of computer systems have been omitted for convenience of illustration, various configurations of a computer system in accordance with an embodiment will be apparent to those skilled in the art based on the descriptions of embodiments provided herein.

For example, a computer system in accordance with an embodiment may include one or more of a processor, a memory, a user input device, a user output device, and a storage. A computer system may also include a network interface that is coupled to a network, e.g., the Internet, and other communication interfaces.

The processor may be a central processing unit (CPU) or a semiconductor device that executes processing instructions stored in the memory and/or the storage. The memory and the storage may include various forms of volatile or non-volatile storage media. For example, the memory may include a read-only memory (ROM) and a random access memory (RAM).

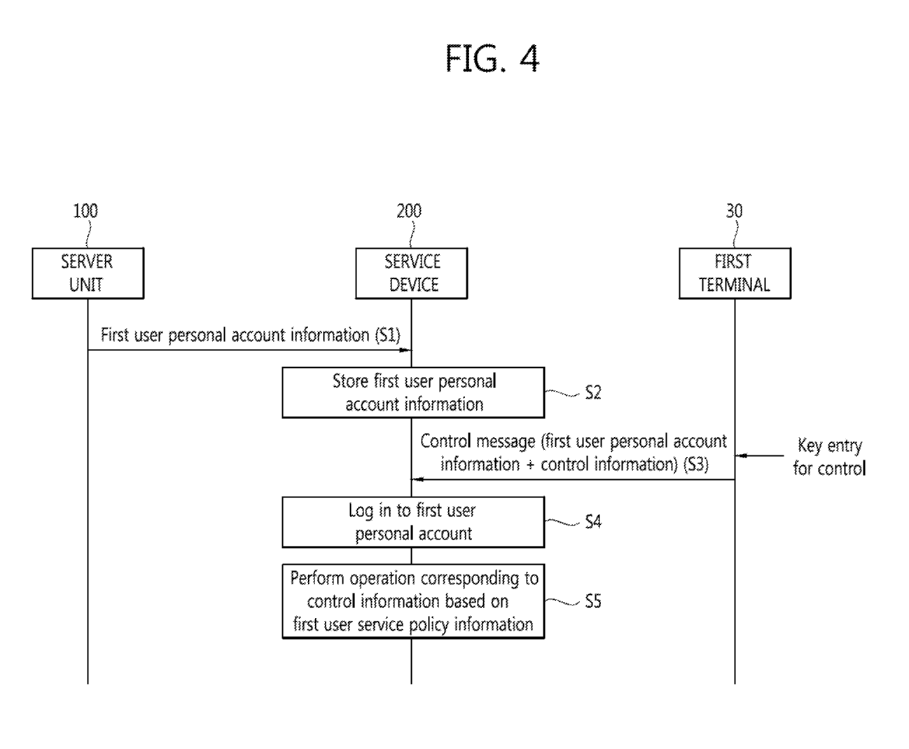

FIG. 4 is a flowchart illustrating an operation of a control system based on a user personal account in accordance with an embodiment of the present invention. For convenience of illustration, FIG. 4 will be described with reference to a first user personal account.

Referring to FIG. 4, the first user may access a user account management user interface (e.g., a webpage), which is managed by the server 100 using a terminal, such as his or her PC or smart phone, and input information to generate a first user personal account. The inputted information may include user personal account identification information (e.g., a user personal account ID), authentication information for identifying a user personal account (e.g., a password, PIN code, a certificate, fingerprint information, etc.), and service device identification information (e.g., MAC information, a model number, a serial number for the service device 200, etc.). In response thereto, the server 100 generates the first user personal account corresponding to the first user.

After the first user personal account is generated, the server 100 identifies the service device 200 based on the inputted service device identification information and sends first user personal account information, corresponding to the first user personal account, to the service device 200 at step S1. The first user personal account information may include the user personal account identification information and the authentication information. For example, the first user personal account information may include a user personal account ID and PIN code.

The service device 200 stores the first user personal account information received from the server 100 at step S2. The first user personal account information may be registered and managed as an individual account in a family account that is stored and managed by the service device 200.

The first user may access the user account management user interface using a terminal having Internet access, and input a desired EPG format, an EPG information display range, programs of interest, and an IPTV service user interface. The server 100 generates first user service policy information, corresponding to the first user personal account, based on the inputted information and sends the first user service policy information to the service device 200. The service device 200 receives the first user service policy information from the server 100 and stores the first user service policy information in association with the first user personal account information.

In an embodiment, the first user may input the first user personal account information through a user interface provided by the first terminal 30. In response thereto, the first terminal 30 may store the first user personal account information.

While using an IPTV service, the first user may input a selection on the first terminal 30 in order to control the service device 200. For example, the first user may select ‘EPG MENU DISPLAY’ in the first terminal 30. In response thereto, the first terminal 30 may send a control message including control information corresponding to the selection, that is, a key control value, and the previously stored first user personal account information, to the service device 200 at step S3.

When the control message is received from the first terminal 30, the service device 200 may log in to the first user personal account, corresponding to the first user personal account information, based on the first user personal account information included in the control message at step S4. For example, the service device 200 may compare user personal account information included in the control message with user personal account information included in family profile information stored thereon, and log in the first user personal account if the user personal account information included in the control message is found to be the first user personal account information included in the family profile information.

Next, the service device 200 performs an operation corresponding to the control information and in accordance with the first user service policy information associated with the first user personal account at step S5. For example, if the control information is a key control value that instructs ‘EPG MENU DISPLAY’, the service device 200 may display an EPG menu specific to the first user based on the first user service policy information associated with the first user personal account.

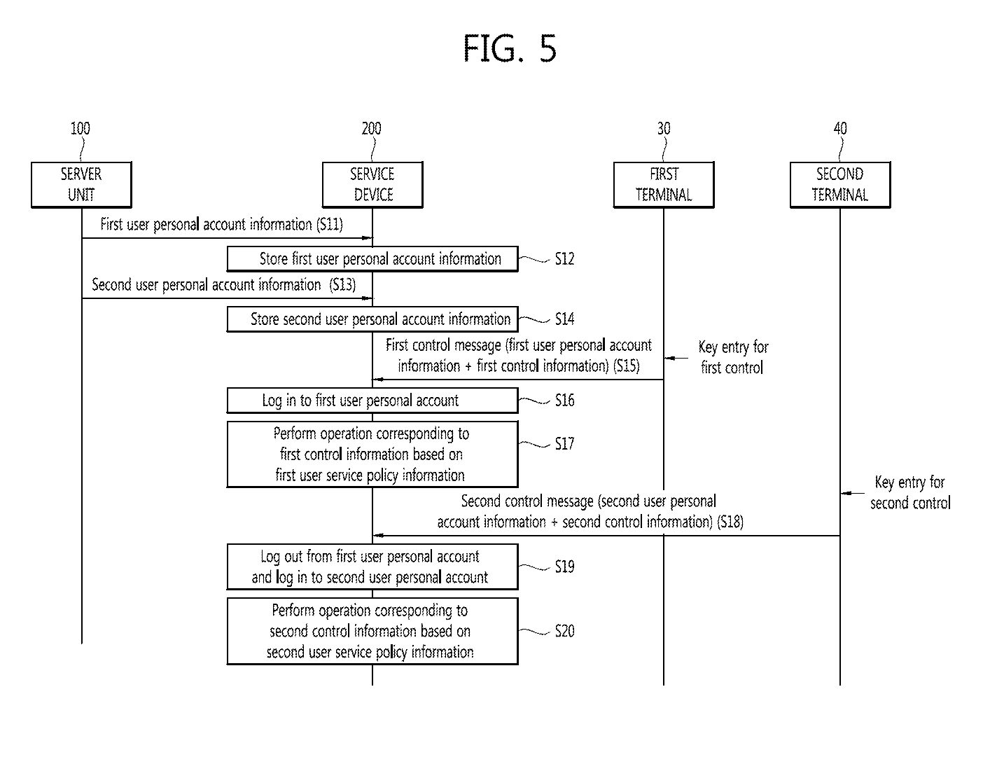

FIG. 5 is a flowchart illustrating another operation of a control system based on a user personal account in accordance with an embodiment of the present invention.

Referring to FIG. 5, a first user may access a user account management user interface (e.g., a webpage), managed by the server 100, using a terminal having web access, such as his or her PC or smart phone, and input information to generate a first user personal account. As described above, the inputted information may include user personal account identification information for the first user personal account, authentication information for identifying a user personal account, and service device identification information. In response thereto, the server 100 my generates the first user personal account corresponding to the first user.

After the first user personal account is generated, the server 100 can identify the service device 200 based on the inputted service device identification information and send first user personal account information corresponding to the first user personal account to the service device 200 at step S11. The first user personal account information may include the user personal account identification information and the authentication information. For example, the first user personal account information may include a user personal account ID and PIN code corresponding to the first user.

The service device 200 stores the first user personal account information received from the server 100 at step S12. The first user personal account information may be registered and managed as an individual account associated with a family account that is stored and managed by the service device 200.

The first user may access the user account management user interface using a terminal having web access and input a desired EPG format, an EPG information display range, programs of interest, and an IPTV service user interface. In response thereto, the server 100 generates first user service policy information corresponding to the first user personal account based on the inputted information and sends the first user service policy information to the service device 200. The service device 200 receives the first user service policy information from the server 100 and stores the first user service policy information in association with the first user personal account information.

A second user may access a user account management user interface managed by the server unit 100 using a terminal having web access, such as his or her PC or smart phone, and input information to generate a second user personal account. The inputted information may include user personal account identification information for a second user personal account, authentication information for identifying a user personal account, and service device identification information. In response to the input information, the server 100 generates the second user personal account corresponding to the second user.

After the second user personal account is generated, the server 100 can identify the service device 200 based on the inputted service device identification information and send second user personal account information, corresponding to the second user personal account, to the service device 200 at step S13. The second user personal account information may include the user personal account identification information and the authentication information. For example, the second user personal account information may include a user personal account ID and PIN code corresponding to the second user.

The service device 200 stores the second user personal account information received from the server 100 at step S14. The second user personal account information may be registered and managed as an individual account associated with the family account that is stored and managed by the service device 200. That is, both the first user personal account information and the second user personal account information may be registered and managed as individual accounts of the family account.

The second user may access the user account management user interface using a terminal having web access and input a desired EPG format, an EPG information display range, programs of interest, and an IPTV service user interface. In response thereto, the server 100 can generate second user service policy information corresponding to the second user personal account based on the inputted information and send the second user service policy information to the service device 200. The service device 200 receives the second user service policy information from the server 100 and stores the second user service policy information in association with the second user personal account information.

In an embodiment, the first user may input the first user personal account information through a user interface provided by his or her first terminal 30. In response thereto, the first terminal 30 stores the inputted first user personal account information. Likewise, the second user may input the second user personal account information through a user interface provided by his or her second terminal 40. In response thereto, the second terminal 40 stores the inputted second user personal account information.

While using an IPTV service, the first user may input a selection on the first terminal 30 in order to control the service device 200. For example, the first user may select ‘EPG MENU DISPLAY’ in the first terminal 30. In response thereto, the first terminal 30 sends a first control message, including first control information, that is, a first key control value and the first user personal account information that has been previously stored, to the service device 200 at step S15.

When the first control message is received from the first terminal 30, the service device 200 logs in to the first user personal account, corresponding to the first user personal account information, based on the first user personal account information included in the first control message at step S16. For example, the service device 200 may check that user personal account information included in the first control message is the first user personal account information by comparing the user personal account information included in the first control message with pieces of user personal account information stored in the database 250. If the user personal account information in the first control message matches the first user personal account information stored in the database, the first user is logged into the first user personal account.

The service device 200 performs an operation corresponding to the first control information based on the first user service policy information associated with the first user personal account at step S17. For example, if the first control information is a key control value that instructs ‘EPG MENU DISPLAY’, the service device 200 may display an EPG menu specific to the first user based on the first user service policy information.

If, while the first user stops using the IPTV service, the second user inputs a selection on the second terminal 40 in order to control the service device 200, the service device 200, which was previously logged into the first user personal account, automatically logs out of the first user personal account and logs into the second user personal account. For example, the second user may select a button ‘INTERESTED PROGRAM LIST DISPLAY’ in the second terminal 40. In response thereto, the second terminal 40 may send a second control message including second control information, that is, a second key control value and the second user personal account information that has been previously stored, to the service device 200 at step S18.

When the second control message is received from the second terminal 40, the service device 200 logs out from the first user personal account and logs in to the second user personal account corresponding to the second user personal account information, based on the second user personal account information included in the second control message at step S19. For example, the service device 200 may confirm that user personal account information included in the second control message is the second user personal account information by comparing the user personal account information included in the second control message with pieces of user personal account information stored in the database 250. The service device 200 may log out of the first user personal account and log in to the second user personal account because the second user personal account included in the control message is different from the currently logged-in account, that is, the first user personal account.

Next, the service device 200 performs an operation corresponding to the second control information based on the second user service policy information associated with the second user personal account at step S20. For example, if the second control information is a key control value that instructs ‘INTERESTED PROGRAM LIST DISPLAY’, the service device 200 may display the interested program list of the second user personal account based on the second user service policy information. Accordingly, the first user does not need to perform an additional logout process, and the second user can be provided with a service specific to the second user without inputting additional information related to a login process.

However, if the service device 200 is still logged into the first user personal account, and the first user inputs another selection on the first terminal 30 in order to control the service device 200, then the second service device 200 remains logged into the first user device. For example, after S17, the first user may select a cursor movement key in order to select a desired item in an EPG menu that is being displayed. In response thereto, the first terminal 30 may send a third control message including third control information corresponding to the selection, that is, a third key value and the first user personal account information that has been previously stored, to the service device 200.

When the third control message is received from the first terminal 30, the service device 200 may maintain the current login state based on the first user personal account information included in the third control message. The service device 200 performs an operation corresponding to the third control information based on the first user service policy information.

If the service device 200 is logged into the first user personal account, and the third user inputs a selection using a third terminal, that is, a common remote controller (that is, a nonregistered remote controller), in order to control the service device 200, the service device 200 logs out of the first user personal account and enters a default log in state. For example, after S17, the third user may select ‘CURSOR MOVEMENT KEY’ in order to select a desired item in an EPG menu that is being displayed while the first user is not using an IPTV service. In response thereto, the third terminal may send a fourth control message including fourth control information corresponding to the selection, that is, a fourth key value, to the service device 200.

In such a case, when the fourth control message is received from the third terminal, the service device 200 may check whether or not user personal account information is included in the fourth control message, log out of the first user personal account, and perform an operation corresponding to the fourth control information in the family account, that is, a default account.

For example, assuming that control information included in the fourth control message is a cursor movement key value that instructs a cursor to be moved in an EPG menu that is displayed only in the first user personal account, the service device 200 may display an error message reading ‘CURSOR CANNOT BE MOVED TO CORRESPONDING ITEM BECAUSE CURRENT ACCOUNT IS NOT A LEGITIMATE ACCOUNT’ and display the EPG menu in the family account. Accordingly, although the first user has stopped using an IPTV service without logging out, a restriction can be imposed so that another user cannot be provided with a service specific to the first user.

As described above, in accordance with an embodiment of the present invention, operation of a device, such as a smart TV or IPTV set-top box capable of providing a family profile service for the members of a family in a home, can be easily controlled without additional login and logout processes based on individual user personal accounts associated with a remote controller or a wireless terminal having a remote controller function.

Although embodiments of the present invention have been described above, a person having ordinary skill in the art will appreciate that embodiments of the present invention may be modified in various ways without departing from the spirit and scope of the present invention defined in the appended claims. Accordingly, possible changes to embodiments of the present invention are deemed to fall within the technology of the present invention.

What is claimed is:

1. A control method based on a user personal account, the control method comprising:
receiving a first control message, comprising first user personal account information and first control information, from a first terminal;
logging in to a first user personal account corresponding to the first user personal account information based on the first user personal account information included in the first control message; and
performing an operation corresponding to the first control information based on first user service policy information associated with the first user personal account.

2. The control method of claim 1, wherein:
the first user personal account information comprises identification information for identifying the first user personal account and authentication information for authenticating the first user personal account, and
the first control information comprises a key control value for controlling a device so that the device performs the operation.

3. The control method of claim 1, further comprising:
storing the first user personal account information received from a server,
wherein the logging in to the first user personal account comprises:
extracting the first user personal account information included in the first control message;
comparing the extracted first user personal account information with the stored first user personal account information; and
logging in to the first user personal account if, as a result of the comparison, the extracted first user personal account information corresponds to the stored first user personal account information.

4. The control method of claim 1, further comprising:
after performing the operation corresponding to the first control information,
receiving a second control message, comprising second user personal account information and second control information, from a second terminal;
logging out of the first user personal account and logging in to a second user personal account corresponding to the second user personal account information, based on the second user personal account information included in the second control message; and
performing an operation corresponding to the second control information based on second user service policy information associated with the second user personal account.

5. The control method of claim 1, further comprising:
after performing the operation corresponding to the first control information,
receiving a third control message, comprising the first user personal account information and third control information, from the first terminal;
maintaining a login state of the first user personal account based on the first user personal account information included in the third control message; and
performing an operation corresponding to the third control information based on the first user service policy information.

6. The control method of claim 1, further comprising:
after performing the operation corresponding to the first control information,
receiving a fourth control message comprising fourth control information from a third terminal;
determining whether or not user personal account information is included in the fourth control message; and
logging out from the first user personal account based on the determination.

7. The control method of claim 6, further comprising performing an operation corresponding to the fourth control information based on family policy information associated with a family account after logging out from the first user personal account if it is determined that personal account information is not included in the fourth control message.

8. The control method of claim 1, further comprising:
receiving family account information from a server upon an initial activation;
storing the family account information;
storing the first user personal account information received from a server; and
registering the first user personal account information received from the server as an individual account associated with the family account information.

9. A device operating based on a user personal account, the device comprising:
a processor; and
a non-transitory computer-readable medium having stored thereon a program that, when executed by the processor, provides an IPTV service, the non-transitory computer-readable medium comprising:
a terminal communication unit configured to receive a first control message, comprising first user personal account information and first control information, from a first terminal;
a login management unit configured to log in to a first user personal account corresponding to the first user personal account information based on the first user personal account information included in the first control message; and
a control unit configured to perform an operation corresponding to the first control information based on first user service policy information associated with the first user personal account.

10. The device of claim 9, wherein the first user personal account information comprises identification information for identifying the first user personal account and authentication information for authenticating the first user personal account, and
wherein the first control information comprises a key control value for controlling the service device so that the service device performs the operation.

11. The device of claim 9, wherein
if the terminal communication unit receives a second control message, comprising second user personal account information and second control information, while the service device is logged in to the first user personal account, the login management unit causes the service device to log out of the first user personal account and log in to a second user personal account corresponding to the second user personal account information, based on the second user personal account information included in the second control message; and
the control unit performs an operation corresponding to the second control information based on second user service policy information associated with the second user personal account.

12. The device of claim 9, wherein:
if the terminal communication unit receives a third control message, comprising the first user personal account information and third control information, from the first terminal while the service device is logged in to the first user personal account, the login management unit maintains a login state of the first user personal account based on the first user personal account information included in the third control message; and
the control unit performs an operation corresponding to the third control information based on the first user service policy information.

13. The device of claim 9, wherein:
if the terminal communication unit receives a fourth control message comprising fourth control information from a third terminal while the service device is logged in to the first user personal account, the login management unit determines whether or not user personal account information is included in the fourth control message and causes the service device to log out of the first user personal account based on the determination.

14. The device of claim 13, wherein the control unit performs an operation corresponding to the fourth control information based on family policy information associated with a predetermined family account after the logout if it is determined that user personal account information is not included in the fourth control message.

15. A control system based on a user personal account, comprising:
a first terminal configured to send a first control message comprising first user personal account information and first control information; and
a service device configured to receive the first control message, log in to a first user personal account corresponding to the first user personal account information based on the first user personal account information included in the first control message, and perform an operation corresponding to the first control information based on first user service policy information associated with the first user personal account.

16. The control system of claim 15, wherein the first user personal account information comprises identification information for identifying the first user personal account and authentication information for authenticating the first user personal account, and
wherein the first control information comprises a key control value for controlling the service device so that the service device performs the operation.

17. The control system of claim 15, further comprising a second terminal configured to send a second control message comprising second user personal account information and second control information,
wherein when the second control message is received from the second terminal after performing the operation corresponding to the first control information, the service device logs out from the first user personal account and logs in to a second user personal account corresponding to the second user personal account information, based on the second user personal account information included in the second control message, and performs an operation corresponding to the second control information based on second user service policy information associated with the second user personal account.

18. The control system of claim 15, wherein the first terminal sends a third control message, comprising the first user personal account information and third control information, to the service device after the service device performs the operation corresponding to the first control information, and
wherein the service device maintains a login state of the first user personal account based on the first user personal account information included in the third control message and performs an operation corresponding to the third control information based on the first user service policy information, when the third control message is received.

19. The control system of claim 15, further comprising a third terminal configured to send a fourth control message comprising fourth control information,
wherein when the fourth control message comprising the fourth control information is received from the third terminal after performing the operation corresponding to the first control information, the service device determines whether or not user personal account information is included in the fourth control message, logs out from the first user personal account, and performs an operation corresponding to the fourth control information based on family policy information associated with a family account if it is determined that user personal information is not included in the fourth control message.

20. The control system of claim 15, further comprising a server configured to generate the first user personal account and send the first user personal account information, corresponding to the generated first user personal account, to the service device.
